(19) United States
(12) Patent Application Publication
(10) Pub. No.: US 2014/0079286 A1
(43) Pub. Date: Mar. 20, 2014

(54) METHOD AND APPARATUS OF OBJECT RECOGNITION

(71) Applicant: ELECTRONICS AND TELECOMMUNICATIONS RESEARCH INSTITUTE, Daejeon (KR)

(72) Inventors: Kang Woo LEE, Daejeon-si (KR); Hyoung Sun KIM, Daejeon-si (KR); Hyun KIM, Daejeon-si (KR)

(73) Assignee: ELECTRONICS AND TELECOMMUNICATIONS RESEARCH INSTITUTE, Daejeon (KR)

(21) Appl. No.: 14/025,926

(22) Filed: Sep. 13, 2013

(30) Foreign Application Priority Data
Sep. 14, 2012 (KR) 10-2012-0102317

(51) Int. Cl. G06K 9/62

(52) U.S. Cl. CPC G06K 9/6202
USPC 382/103

(57) ABSTRACT

A method for object recognition recognizing an object included in an image comprises extracting image features from the image; extracting a first candidate object matched to each of the image features with the highest similarity score from among objects within an object database which previously stores information about a target object for recognition; extracting a second candidate object based on a first matching score of the first candidate object; and based on a second matching score of the second candidate object calculated by matching features of the second candidate object and the image features, recognizing whether the second candidate object is the target object included in the image.

### CROSS-REFERENCE TO RELATED APPLICATIONS

This application claims the benefit of priority of Korean Patent Application No. 10-2012-0102317 filed on Sep. 14, 2012, all of which is incorporated by reference in its entirety herein.

### BACKGROUND OF THE INVENTION

1. Field of the invention

The present invention relates to a method and apparatus for recognizing objects and more particularly, a method and apparatus for recognizing objects included in an image.

2. Related Art

Image-based object recognition (for example, recognition of things, humans, and so on) are carried out by various algorithms. Object recognition is a technology in wide use not only for applications of recognition of simple objects but also for more sophisticated applications such as robot tasks.

One of major application fields utilizing image-based object recognition constructs a database beforehand by collecting images of objects for recognition and then determines whether an object registered in the database exists in an image captured through a camera.

For example, in one method, image features are extracted from object images registered in the database by using a technique such as SURF (Speeded Up Robust Features), SIFT (Scale Invariant Feature Transform), and so on; descriptors are generated to represent the extracted features and stored in the database beforehand. Afterwards, if an image is obtained, feature descriptors extracted from the obtained image are compared with those stored in the database and the database is searched for an object which shows the best match.

However, a feature matching method using the aforementioned technique such as SURF and SIFT requires lots of computing resources for extracting features and generating descriptors and subsequently, matching the descriptors with those stored in a large-scale object database. In particular, in the case of sequential pair-wise matching between the features extracted from an image and those features registered in a database consumes a lot more computing resources and time.

To solve such a problem, one method matches features extracted from an image with the whole object features registered in a database all at once. This method can reduce a burden inherent in the method which performs sequential pair-wise matching between features in a target image and those registered in a database; however, this method reveals performance degradation in terms of recognition accuracy. Also, in case the number of features extracted from an image varies according to a feature extraction algorithm employed, a matching score can be varied even for the same image depending on the number of features of the corresponding object registered in a database.

Therefore, there needs a method capable of improving accuracy of object recognition while at the same time reducing a burden according to the object recognition and providing a matching score in a reliable manner irrespective of the number of features.

### SUMMARY OF THE INVENTION

The present invention has been made in an effort to provide a method and apparatus for recognizing objects included in an image.

The present invention has been made in an effort to provide a method and apparatus which extract features from an image meant for object recognition and matches a target object in the image with the most similar object in a database by comparing the extracted features of the target object with those of objects in the object database constructed previously.

A method for object recognition recognizing an object in an image according to one embodiment of the present invention comprises extracting image features from the image, extracting a first candidate object matched to each of the image features with the highest similarity score from among objects within an object database which previously stores information about a target object for recognition, extracting, a second candidate object based on a first matching score of the first candidate object, and based on a second matching score of the second candidate object calculated by matching features of the second candidate object and the image features, recognizing whether the second candidate object is the target object included in the image.

The extracting the first candidate object comprises matching features of each object within the object database to each of the image features all at once; extracting features matched with the highest similarities respectively to each of the image features; and determining an object corresponding to the individual features with the highest similarities as the first candidate object.

The first matching score refers to the number of the features with the highest similarities included within the first candidate object divided by the number of compensated features of the first candidate object, where the number of the compensated features may correspond to a compensated value of the total number of features of the first candidate object by using a predetermined function.

The second matching score may correspond to the number of the image features matched to features of the second candidate object divided by the total number of features of the second candidate object.

If the first matching score is equal to or over a predetermined reference matching score, the second candidate object can be determined as a matched object

If the second matching score is equal to or over a predetermined reference matching score, it can be decided that the second candidate object is included in the image.

An apparatus for object recognition recognizing an object included in an image according to another embodiment of the present invention comprises a first matching unit which extracts a first candidate object matched with the highest similarity to the individual image features from among objects within an object database previously storing information about a target object for recognition; a second matching unit which extracts a second candidate object based on the first matching score and calculates a second matching score of the second candidate object by matching the second candidate object's features to the image features; and an object recognition unit which decides based on the second matching score whether the second candidate object is an object included in the image.

The first matching unit comprises a first candidate object determination unit which matches features of each object within the object database to the individual image features all at once and extracts features matched to the individual image features with the highest similarities and determines an object corresponding to each of the features with the highest similarities as the first candidate object; and a first matching score determination unit which determines the first matching score as the number of the most similar features included in the first candidate object divided by the number of compensated features of the first candidate object.

The number of compensated features may correspond to a compensated value of the total number of features of the first candidate object by using a predetermined function.

The second matching unit comprises a second candidate determination unit which determines an object as the second candidate object if the first matching score is equal to or over a predetermined matching score; and a second matching score determination unit which determines the second matching score as the number of the image features divided by the number of total features of the second candidate object.

The object recognition unit can determine that the second candidate object is included in the image if the second matching score is equal to or over a predetermined reference matching score.

The apparatus for object recognition can further comprise a feature extraction unit extracting image features.

### BRIEF DESCRIPTION OF THE DRAWINGS

FIG. 1 illustrates one example of a method for recognizing an object included in an image through linear matching with an object stored in an object database.

FIG. 2 illustrates one example of a method for recognizing an object included in an image through matching to an object stored in an object database with the highest similarity score.

FIG. 3 illustrates one example of a method for recognizing an object included in an image through matching to an object with the highest similarity score in case a new object is registered in the object database of FIG. 2.

FIG. 4 is a flow diagram illustrating a method for object recognition according to an embodiment of the present invention.

FIG. 5 is a block diagram briefly illustrating an apparatus for recognizing an object included in an image according to an embodiment of the present invention.

### DESCRIPTION OF EXEMPLARY EMBODIMENTS

In what follows, embodiments of the present invention will be described in detail with reference to appended drawings for those skilled in the art to which the present invention belongs to perform the present invention. The present invention is not limited to embodiments described below but can be applied in various other forms within the technical scope of the present invention.

Depending on the needs, constituting elements of the present invention can include additional elements not described in this document; detailed descriptions will not be provided for those elements not directly related to the present invention or overlapping parts thereof. Disposition of each constituting element described in this document can be adjusted according to the needs; one element can be incorporated into another element and similarly, one element can be divided into two or more elements.

A method for object recognition using SIFT (Scale Invariant Feature Transform) or SURF (Speeded Up Robust Features) algorithm extracts image features of two objects in question and matches extracted features descriptors of the two objects with each other. If the number of matched features exceeds a predetermined value, the two objects are determined to be the same.

One of major applications of this method stores information about a target object for recognition beforehand in an object database and later extracts features from an image obtained through a camera, TV, and the like and matches the extracted features to those features of the target object stored in the object database. If a matching score between an object stored in the database and an image obtained through a camera, TV, and the like exceeds a predetermined value, it is decided that the corresponding object exists in the image.

Here, SIFT algorithm refers to a method of extracting image features invariant to scaling and rotation while SURF algorithm extracts image features invariant to environment change from integral images by taking account of the environment change such as scale, illumination, viewpoint, and so on.

Meanwhile, an object refers to a human, thing, image, or text. The image may correspond to a still image or moving image. For example, images can be obtained from a camera installed in a mobile device such as a smart phone or from a TV program (for example, drama, movie, advertisement, and so on). Similarly, images can be obtained from CCTV. The images obtained from the sources described above may include various kinds of objects such as a bag, shoes, watch, car, particular body part, human, characters, and so on. Also, a plurality of objects can be included in the images obtained.

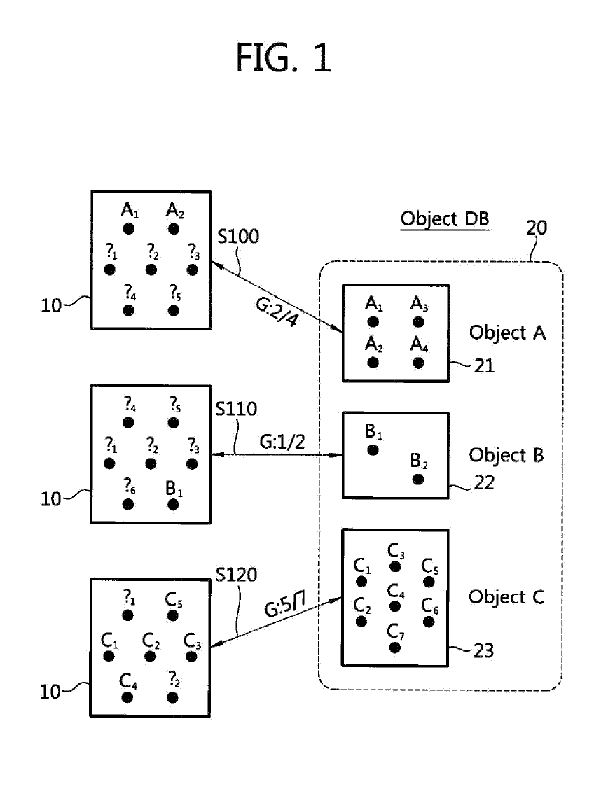

FIG. 1 illustrates one example of a method for recognizing an object included in an image through linear matching with an object stored in an object database.

With reference to FIG. 1, the object database 20 stores a target object for recognition and information about the, object. For example, an image of a target object for recognition is secured previously and feature information extracted from the object image and additional information of the object are stored. As one example, as shown in FIG. 1, the object database 20 can pre-store an object A21, object B22, and object C23.

Meanwhile, in case an image 10 is obtained through a medium such as a camera or TV and an object belonging to the image 10 is to be recognized, features are extracted from the image 10. For example, features of the image 10 can be extracted by using SIFT or SURF algorithm, where in the case of FIG. 1, a total of seven features are extracted from the image 10.

The extracted features of the image 10 are matched to the object A21 stored in the object database 20 and a matching score G representing a degree of matching is calculated S100.

For example, if features of the image 10 are matched to the features of the object A21, the features of the image 10 are matched to A1 and A2 feature among the features of the object A21. Therefore, a matching score for the object A21 is obtained as 2/4, which is the number of matching features between the image 10 and the object A21 divided by the total number of features.

Next, the extracted features of the image 10 are matched to the object B22 stored in the object database 20 and a matching score G representing the degree of matching is calculated S110.

For example, if features of the image 10 are matched to the features of the object B22, the features of the image 10 are matched to B1 feature among the features of the object B22. Therefore, a matching score for the object B22 is obtained as 1/2, which is the number of matching features between the image 10 and the object B22 divided by the total number of features.

Next, the extracted features of the image 10 are matched to the object C23 stored in the object database 20 and a matching score G representing the degree of matching is calculated S120.

For example, if features of the image 10 are matched to the features of the object C23, the features of the image 10 are matched to C1, C2, C3, C4 and C5 feature among the features of the object C23. Therefore, a matching score for the object C23 is obtained as 5/7, which is the number of matching features between the image 10 and the object C23 divided by the total number of features.

If a minimum matching score for recognition of an object included in an image is 0.5, it can be decided that the image 10 includes all of the objects A21, B22, and C23. Similarly, if the minimum matching score is 0.55, it can be decided that the image 10 includes only the object C23.

The method for object recognition described above uses a linear matching method which performs sequential pair-wise matching between image features and object features stored in an object database and therefore, can be regarded as a very intuitive approach. Also the method for object recognition described above provides an advantage in that a matching score for an object is always calculated the same irrespective of the number of objects stored in an object database. However, since the linear matching method increases the number of trials for matching a target object to individual objects as the number of objects stored in the object database is increased, speed for object recognition is decreased and performance is degraded due to a large consumption of computing resources.

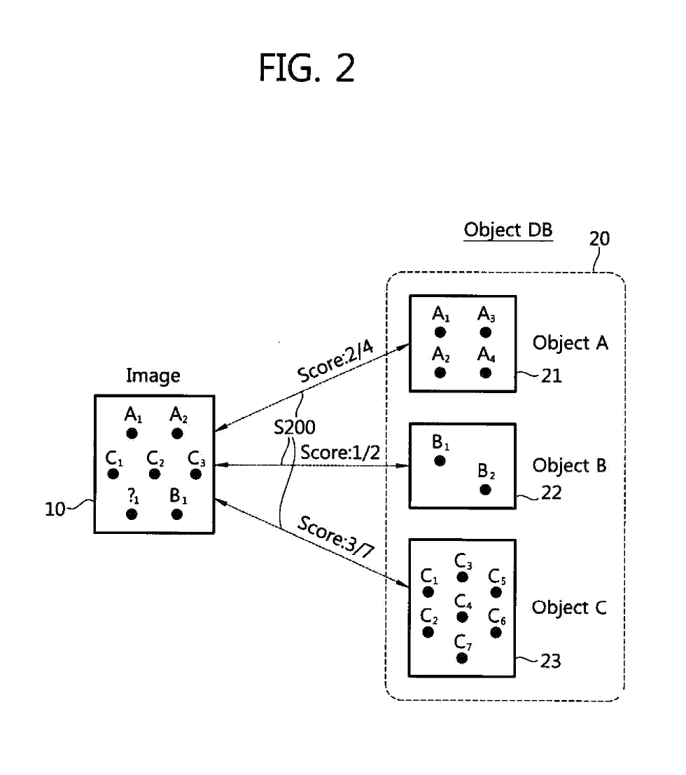

As a partial remedy for decrease of object recognition speed according to the increase of the number of objects in an object database described above, a method of matching image features to the objects stored in the object database altogether may be employed. This method will be described with reference to FIG. 2.

FIG. 2 illustrates one example of a method for recognizing an object included in an image through matching to an object stored in an object database with the highest similarity score.

With reference to FIG. 2, features of an image 10 are matched to an object A21, object B22, and object C23 stored in an object database 20 at the same time and each feature of the image 10 is matched to a feature of an object showing the highest similarity score S200.

For example, FIG. 2 shows an example where each feature of the image 10 is matched to the whole objects within the object database 20 and each feature of the image 10 is matched with the highest similarity score to the features A1 and A2 of the object A 21; feature B1 of the object B22; and features C1, C2, and C3 of the object C23.

At this time, the matching score from the object A21 becomes 2/4, which is obtained as the number of features of the object A21 (A1 and A2) matched to the features of the image 10 with the highest similarity score divided by the total number of features of the object A21.

The matching score from the object B22 becomes 1/2, which is obtained as the number of features of the object B22 (B1) matched to the features of the image 10 with the highest similarity score divided by the total number of features of the object B22.

The matching score from the object C23 becomes 3/7, which is obtained as the number of features of the object C23 (C1, C2, and C3) matched to the features of the image 10 with the highest similarity score divided by the total number of features of the object C23.

If a minimum matching score for recognition of an object included in an image is 0.5, it can be decided that the image 10 includes the object A21 and B22.

The method for object recognition using nearest neighbor matching to the whole objects within an object database of objects within a predetermined range described above can provide an object matching speed higher than that of the linear matching method described with reference to FIG. 1. For example, if k-d tree or hash-based multi-dimensional index is utilized, the nearest neighbor matching can be carried out at the same time with individual objects within an object database.

The multi-dimensional index refers to a structure devised for an effective similarity search of data within a database; for example, by using k-d tree or hash value, multi-dimensional data such as point, line, surface, and so on can be searched for and stored efficiently.

Also, the method for object recognition through nearest neighbor matching described above adds a relatively small increase of computational burden even if the number of objects stored in an object database is increased. However, the method can give rise to the following two problems.

First, if the number of object features is excessively large or small, a matching score may not be calculated accurately. For example, in the case of the object B22, only one feature B1 is matched with the highest similarity score to a feature of the image 10; since the total number of features of the object B22 is 2, the matching score is calculated as 0.5 and thus the object B22 can be interpreted to be included in the image 10. Meanwhile, in the case of the object C23, three features (C1, C2, and C3) are matched with the highest similarity score to the features of the image 10; since the total number of features of the object C23 is 7, the matching score is obtained as a value smaller than 0.5 and thus the object C23 is interpreted not to be include in the image 10.

In other words, in case the number of features of an object is excessively small and an image feature is matched to a feature within an object by chance, the object can be considered to be included in the image. On the other hand, if the number of features of an object is excessively large, for example, if part of an object is occluded in an image, the matching score becomes small even if a relatively large number of features in the image are matched to object features in an object database, and thus the object can be considered not to be included in the image.

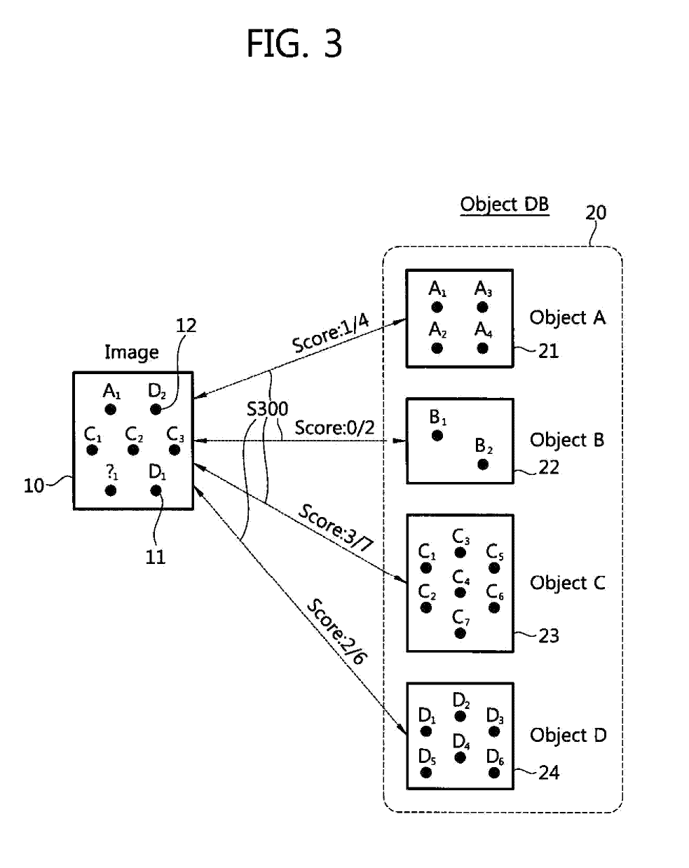

Second, if a new object is added to an object database, there are chances that the corresponding matching score is changed for the same image. This situation will be described with reference to FIG. 3.

FIG. 3 illustrates one example of a method for recognizing an object included in an image through matching to an object with the highest similarity score in case a new object is registered in the object database of FIG. 2.

With reference to FIG. 3, a new object for recognition D24 is added to the object database 20 and information of features of the object D24 is stored in the object database 20. As a matter of course, information about the object D24 can be stored in addition, to the features.

Features of the image 10 are matched to an object A21, object B22, object C23, and object D24 stored in an object database 20 at the same time, where each feature of the image 10 is matched to a feature of an object showing the highest similarity score S300.

At this time, a feature of the image 10, which was matched to the feature B1 of the object B22 in the case of FIG. 2, is now matched to a feature D1 11 of the object D24 in the case of FIG. 3, changing the matching score for the object B22 from 1/2 to 0/2. Likewise, a feature of the image 10, which was matched to the feature A2 of the object A 21 in the case of FIG. 2, is now matched to a feature D2 12 of the object D24 in the case of FIG. 3, changing the matching score for the object A21 from 2/4 to 1/4.

If a minimum matching score is set to 0.5, it is decided that no object is included in the image 10.

As described above, if anew, object is stored in an object database, since an object feature matched with the highest similarity score to each of image features is changed for the same image, it gives rise to a problem that a matching score for each object is subsequently changed. In addition, as the number of objects stored in an object database is increased, the corresponding matching score is decreased on the whole; thus, the minimum matching score has to be continuously updated for proper object recognition.

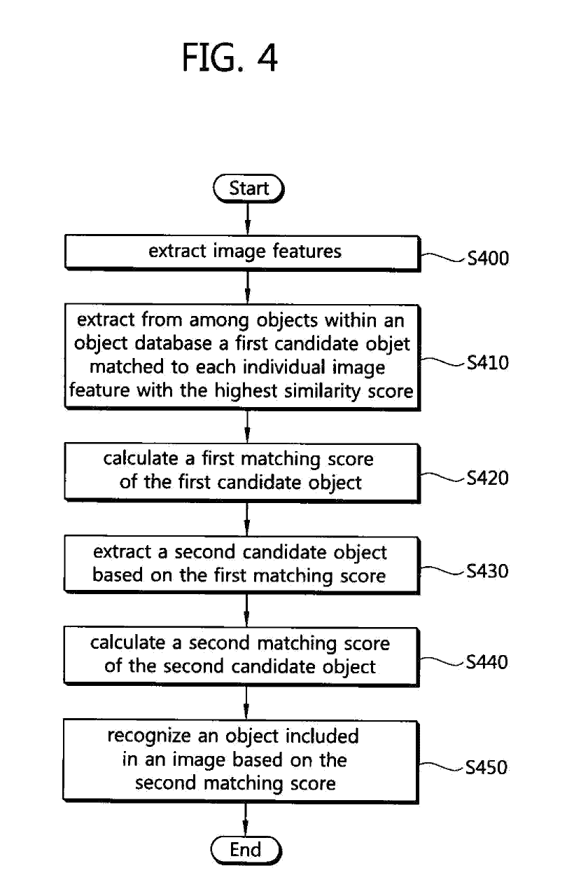

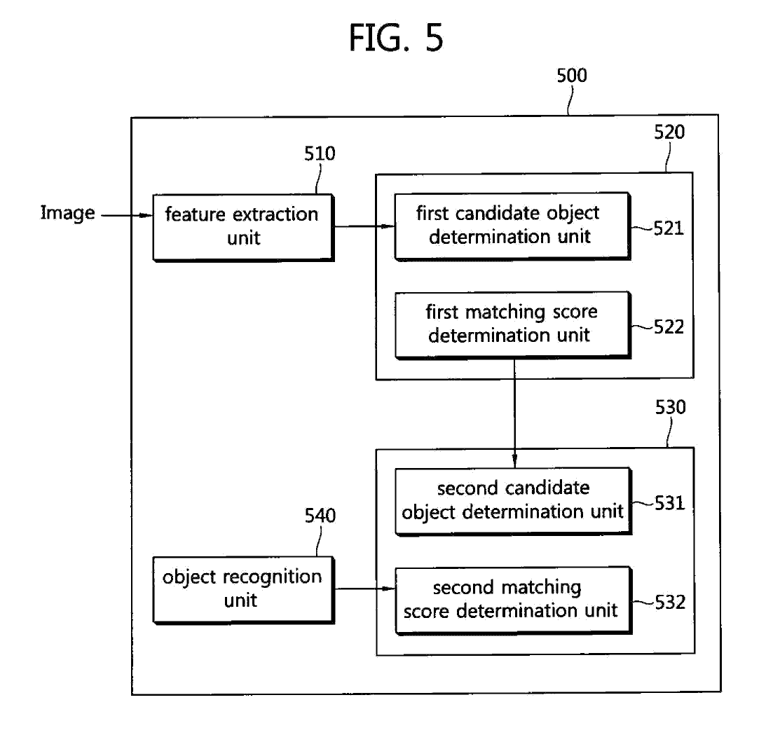

In what follows, a method and apparatus for object recognition according to the present invention will be described with reference to FIGS. 4 and 5. The present invention solves the problem of accuracy degradation of a matching score when the number of object features is excessively small or large; and the problem of change of a matching score for each object according as the number of objects stored in an object database is changed, thereby providing a method and apparatus for object recognition capable of calculating a matching score in a more accurate and reliable manner.

FIG. 4 is a flow diagram illustrating a method for object recognition according to an embodiment of the present invention.

With reference to FIG. 4, image features are extracted from an image obtained through a medium such as a camera, TV, and the like S400. For example, image features can be extracted from an image by applying a feature extraction algorithm such as SIFT, SURF, and so on.

A first candidate object, which is matched with the highest similarity score to each feature of a target image, is then extracted from among objects within an object database already storing information about the target object for recognition S410.

More specifically, features of each object within the object database are matched to each individual feature of the target image at the same time and each of those features matched with the highest similarity score to each individual feature of the target image is extracted. An object corresponding to the extracted features with the highest similarity score is determined as the first candidate object. The above procedure can be carried out by using a nearest neighbor matching method as described in detail with reference to FIG. 2 and features of the target image are matched at the same time against the whole objects within the object database or those objects belonging to a predetermined range.

For example, a feature descriptor representing information about an image feature can be matched to the feature descriptors of individual objects within the object database by using a multi-dimensional index. At this time, among feature descriptors of the individual objects, those features identical or most similar to the feature descriptors of the target image are detected as nearest neighbor features; and first candidate objects are determined by extracting the objects corresponding to the detected nearest neighbor features.

A first matching score of the first candidate object extracted in the step S410 is calculated S420. In other words, the first matching score is determined for each individual first candidate objects as the number of the nearest neighbor features included in the first candidate object divided by the number of compensated features of the first candidate objects.

The number of compensated features refers to a value obtained by compensating the total number of features of the first candidate objects by using a predetermined function. For example, by compensating the total number of features of an object by employing a function such as a log function whose value increases relatively gradually as the function's independent variable is increased, a distortion effect inherent in a matching score that may occur when the number of object features is excessively large or small can be removed.

For example, a procedure of calculating a first matching score of a first candidate object according to the present invention will be described with reference to FIG. 2.

First, the nearest neighbor features matched to each of features of a target image with the highest similarity score are obtained as A1, A2, B1, C1, C2, C3 from the step S410, those objects corresponding to the nearest neighbor features A21, B22, C23 are extracted as the first candidate objects.

Next, the matching score of each of the first candidate objects according to the present invention can be calculated as follows. The first matching score of the object A21 is obtained as the number of the nearest neighbor features included in the object A21, 2, divided by the number of compensated features of the object A21; in other words, the first matching score of the object A21 is a value obtained from the total number of the nearest neighbor features of the object A21 divided by the number of features of the object A21 compensated by a log function ln(4)=1.386, which is finally 1.443.

The first matching score of the object B22 is a value obtained from the number of the nearest neighbor features included in the object B22, 1, divided by the number of compensated features of the object B22, in(2)=0.693, which is 1.443.

The first matching score of the object C23 is a value obtained from the number of the nearest neighbor features included in the object C23, 3, divided by the number of compensated features of the object C23, in(7)=1.95, which is 1.54.

Based on the first matching score of the first candidate object calculated from the step S420, a second candidate object is extracted S430. In other words, if the first matching score of the first candidate object is equal to or over a predetermined reference matching score, the corresponding candidate object is determined as a second candidate object.

For example, if the reference matching score for a second candidate object is 1.5 or more, the object C23, whose first matching score is 1.54, is determined as a second candidate object.

By matching the second candidate object extracted from the step S430 to the features of the target object, a second matching score of the second candidate object is calculated S440. In other words, by using the linear matching method described with reference to FIG. 1, each individual feature of the second candidate object is matched to the features of the target image in a sequential pair-wise manner. Based on a matching result against each second candidate object, a second matching score is calculated. The second matching score is obtained as the number of target image features matched to the features of the second candidate object divided by the total number of features of the second candidate object.

For example, since five matched features are obtained from matching image features to the features of the object C23 which is determined as the second candidate object, the second matching score of the object C23 is calculated as 5/7 (see FIG. 1).

Based on the second matching score calculated from the step S440, it is decided whether the second candidate object is included in the target image. In other words, if the second matching score of the second candidate object is equal to or over a predetermined reference matching score, it is decided that the second candidate object is included in the target image.

For example, if the reference matching score for object recognition is 0.5 or more, it is decided that the object C23 is included the target image.

FIG. 5 is a block diagram briefly illustrating an apparatus for recognizing an object included in an image according to an embodiment of the present invention.

With reference to FIG. 5, the apparatus for object recognition comprises a feature extraction unit 510, a first matching unit 520, a second matching unit 530, and an object recognition unit 540.

The feature extraction unit 510 extracts image features from an image obtained through a medium such as a camera, TV, and the like. For examples, image features can be extracted from an image by applying a feature extraction algorithm such as SIFT, SURF, and so on.

The first matching unit 520 extracts a first candidate object, which is matched with the highest similarity score to each feature of a target image, from among objects within an object database already storing information about the target object for recognition and calculates a first matching score of the extracted first candidate object.

The first matching unit 520 can comprise a first candidate object determination unit 521 and a first matching score determination unit 522.

The first candidate object determination unit 521 matches features of each object within the object database to each individual feature of the target image at the same time and extracts each of those features matched with the highest similarity score to each individual feature of the target image. An object corresponding to the extracted features with the highest similarity score is determined as the first candidate object. The above procedure can be carried out by using a matching method as described with reference to FIG. 2.

The first matching score determination unit 522 determines the first matching score as the number of the nearest neighbor features included in the first candidate object divided by the number of compensated features of the first candidate objects.

The number of compensated features refers to a value obtained by compensating the total number of features of the first candidate objects by using a predetermined function. For example, the total number of features can be compensated by employing a function such as a log function whose value increases relatively gradually as'the function's independent variable is increased.

The second matching unit 530 extracts a second candidate object based on the first matching score and calculates a second matching score of the second candidate object by matching features of the extracted second candidate object to the features of the target image. At this time, matching, between the features of the second candidate object and the features of the target image is carried out by using a matching method described with reference to FIG. 1.

The second matching unit 530 can comprise a second candidate object determination unit 531 and a second matching score determination unit 532.

If the first matching score calculated by the first matching score determination unit 522 is equal to or over a predetermined reference matching score, the second candidate object determination unit 531 determines the first candidate object as a second candidate object.

For each individual second candidate object, the second matching score determination unit 532 determines a second matching score as the number of features of the second candidate object and their matched features of the target image divided by the total number of features of the second candidate object.

The object recognition unit 540 decides whether the second candidate object is an object included in the target image based on the second matching score calculated by the second matching score determination unit 532. For example, if the second matching score is equal to or over a predetermined reference matching score, the second candidate object can be recognized as the object included in the target image.

The method and apparatus for object recognition according to the present invention described above solves a problem of degradation of matching speed or increase of computational load by using a nearest neighbor matching method between a target image and objects. Also, to ensure calculation of a matching score without being, affected by the number of objects within an object database and the number of features of an object, the number of features of an object is compensated, thereby solving the problem that the matching score is distorted or changed.

Therefore, the present invention can provide a more stable and reliable method and apparatus for object recognition.

According to the present invention, degradation of matching speed and performance occurred at the time of matching an object within a pre-constructed object database to an image can be improved. Also, the present invention improves a situation where a matching score is distorted according to the number of features of an object or a matching score of each object is changed as the number of objects within an object database is increased. Therefore, the present invention can significantly improve a matching speed and perform stable and reliable object recognition.

Descriptions of this document are just examples to illustrate the technical principles of the present invention and various modifications are possible for those skilled in the art to which the present invention belongs without departing from the scope of the present invention. Therefore, the embodiments disclosed in this document are not intended for limiting but for describing the technical principles of the present invention; therefore, the technical principles of the present invention are not limited by the embodiments disclosed in this document. The scope of the present invention should be defined by appended claims and all the technical principles within the equivalent of the scope defined by the appended claims should be interpreted to belong to the technical scope of the present invention.

What is claimed is:

1. In a method for object recognition recognizing an object included in an image, a method for object recognition, comprising:
extracting image features from the image;
extracting a first candidate object matched to each of the image features with the highest similarity score from among objects within an object database which previously stores information about a target object for recognition;
extracting a second candidate object based on a first matching score of the first candidate object; and
based on a second matching score of the second candidate object calculated by matching features of the second candidate object and the image features, recognizing whether the second candidate object is the target object included in the image.

2. The method of claim 1, wherein the extracting the first candidate object comprises matching features of each object within the object database to each of the image features all at once; extracting features matched with the highest similarities respectively to each of the image features; and determining an object corresponding to the individual features with the highest similarities as the first candidate object.

3. The method of claim 2, wherein the first matching score is the number of the features with the highest similarities included within the first candidate object divided by the number of compensated features of the first candidate object, where the number of the compensated features corresponds to a compensated value of the total number of features of the first candidate object by using a predetermined function.

4. The method of claim 1, wherein the second matching score corresponds to the number of the image features matched to features of the second candidate object divided by the total number of features of the second candidate object.

5. The method of claim 1, wherein, if the first matching score is equal to or over a predetermined reference matching score, the second candidate object is determined as a matched object.

6. The method of claim 1, wherein, if the second matching score is equal to or over a predetermined reference matching score, it is decided that the second candidate object is included in the image.

7. In an apparatus for object recognition recognizing an object included in an image, an apparatus for object recognition, comprising:
a first matching unit which extracts a first candidate object matched with the highest similarity to the individual image features from among objects within an object database previously storing information about a target object for recognition;
a second matching unit which extracts a second candidate object based on the first matching score and calculates a second matching score of the second candidate object by matching the second candidate object's features to the image features; and
an object recognition unit which decides based on the second matching score whether the second candidate object is an object included in the image.

8. The apparatus of claim 7, wherein the first matching unit comprises:
a first candidate object determination unit which matches features of each object within the object database to the individual image features all at once and extracts features matched to the individual image features with the highest similarities and determines an object corresponding to each of the features with the highest similarities as the first candidate object; and
a first matching score determination unit which determines the first matching score as the number of the most similar features included in the first candidate object divided by the number of compensated features of the first candidate object,
where the number of compensated features corresponds to a compensated value of the total number of features of the first candidate object by using a predetermined function.

9. The apparatus of claim 7, wherein the second matching unit comprises a second candidate determination unit which determines an object as the second candidate object if the first matching score is equal to or over a predetermined matching score; and
a second matching score determination unit which determines the second matching score as the number of the image features divided by the number of total features of the second candidate object.

10. The apparatus of claim 7, wherein the object recognition unit determines that the second candidate object is included in the image if the second matching score is equal to or over a predetermined reference matching score.

11. The apparatus of claim 7, further comprising a feature extraction unit extracting image features from the image.
